(19) United States
(12) Patent Application Publication
(10) Pub. No.: US 2004/0100110 A1
(43) Pub. Date: May 27, 2004

(54) Ceramic end effector for micro circuit manufacturing

(75) Inventors: Paul W. Baumann, Georgetown, MA (US); Michel Pharand, Chelmsford, MA (US); Donald N. Polner, Marblehead, MA (US)

Correspondence Address: WATTS, HOFFMANN, FISHER & HEINKE CO., L.P.A., Ste. 1750, 1100 Superior Ave., Cleveland, OH, 44114, US

(73) Assignee: Axcelis Technologies, Inc.

(21) Appl. No.: 10/305,731

(22) Filed: Nov. 26, 2002

(51) Int. Cl. B25J 15/06

(52) U.S. Cl. 294/64.1; 414/941

(57) ABSTRACT

An end effector for installation on a robotic arm for transporting a plurality of semiconductor wafers from one location to another features a ceramic end effector body portion that includes a plurality of wafer engaging fingers that each feature wafer support pads. The wafer support pads are adapted to support a semiconductor wafer surface, and at least one of the support pads has a vacuum orifice. The body portion features an interior vacuum passageway having a first end that is adapted to connect to a vacuum source and a second end that terminates at the vacuum orifices such that a reduced gas pressure at the first end causes a vacuum to be exerted at the vacuum orifices. The interior passageway is formed from a groove in the end effector body portion and an end effector backplate that is sealingly connected to the end effector body portion to completely cover the groove from the first end to the second end. The ceramic body portion can be made of alumina or silicon carbide.

### TECHNICAL FIELD

The present invention relates generally to semiconductor wafer processing and more specifically to an end effector for handling semiconductor wafers during processing.

### BACKGROUND OF THE INVENTION

Thermal processing systems are widely used in various stages of semiconductor fabrication. Basic thermal processing applications include chemical deposition, diffusion, oxidation, annealing, silicidation, nitridation, and solder re-flow processes. Many of these thermal processes involve extremely high temperatures. For example, vertical rapid thermal processing (RTP) systems comprise a vertically oriented processing chamber that is heated by a heat source such as a resistive heating element or a bank of high intensity light sources. The heat source is capable of heating the interior of the processing chamber to temperatures in the range of 450-1400 degrees Centigrade at ramp rates of up to about 50 degree C./sec.

Semiconductor thermal processing must be performed in an environment that is relatively free of contamination. One source of contamination that is detrimental to thermal processes is metal. For example, metals such as iron, sodium, and chromium in concentrations as little as 1×e¹⁰ atoms per cubic centimeter will significantly lower the yield from a wafer.

To maximize throughput and minimize contamination, all of the operations that occur during thermal processing of semiconductor wafers are automated. Robotic handlers routinely move wafers into and out of processing chambers. These handlers often employ end effectors disposed at the end of a robotic arm to grip and manipulate the wafer. Key features of end effectors include reliable gripping and minimal impact on the wafer surface. One type of end effector features one or more vacuum devices mounted on the end effector that use suction to grip the wafer and to give a positive indication that the wafer is positioned properly. Some existing vacuum type end effectors have plastic components such as wafer support pads that are not suitable for high temperature thermal processes because they would melt on contact with the heated wafer. Other vacuum type end effectors have metal components such as vacuum lines that make them susceptible to metal contamination within the processing chamber.

### SUMMARY OF THE INVENTION

A ceramic end effector with an interior passage for vacuum provides relatively low cost, lightweight, and contaminate free wafer handling for high temperature thermal processing applications.

An end effector for installation on a robotic arm for transporting a plurality of semiconductor wafers from one location to another is provided that features a ceramic end effector body portion that includes a plurality of wafer support pads. The wafer support pads are adapted to support a semiconductor wafer surface, and at least one of the support pads has a vacuum orifice. The body portion features an interior vacuum passageway having a first end that is adapted to connect to a vacuum source and a second end that terminates at the vacuum orifice such that a reduced gas pressure at the first end causes a vacuum to be exerted at the vacuum orifice. In one embodiment, the interior passageway is formed from a groove in the end effector body portion and an end effector backplate that is sealingly connected to the end effector body portion to completely cover the groove from the first end to the second end. The ceramic body portion can be made of alumina or silicon carbide. In an exemplary embodiment, the end effector has three wafer engaging fingers, two of which have wafer support pads that include vacuum orifices.

### BRIEF DESCRIPTION OF THE DRAWINGS

FIG. 1 is an overview drawing of a robot featuring an end effector constructed according to an embodiment of the present invention loading an RTP process chamber;

FIG. 2A is a perspective view of an end effector constructed in accordance with an embodiment of the present invention;

FIG. 2B is a top plan view of the end effector of FIG. 2A;

FIG. 2C is a side view of the end effector of FIG. 2A; and

FIG. 2D is a top view of a backplate for the end effector of FIG. 2A.

### DETAILED DESCRIPTION OF THE PREFERRED EMBODIMENT

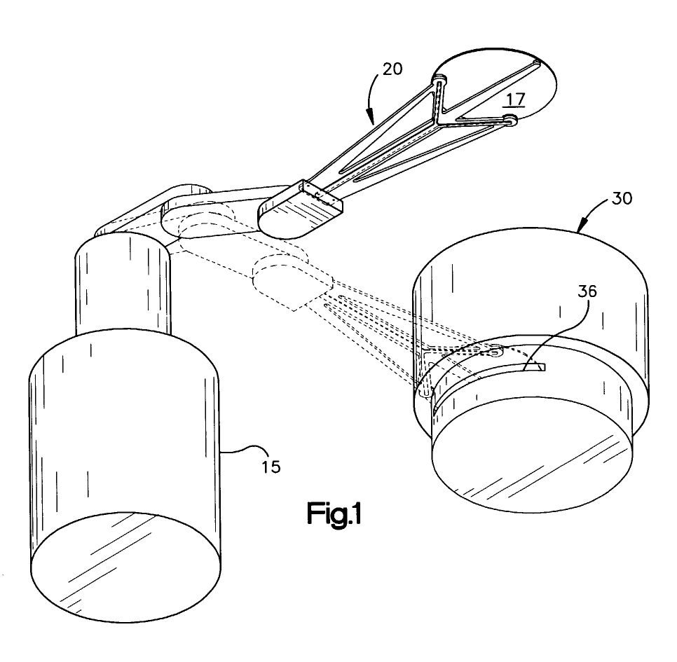

FIG. 1 shows an overview of an end effector 20 installed on a typical wafer handling robot 15 that is loading an RTP machine 30. The end effector 20 grips a wafer 17 and installs it through a slot 36 into the RTP processing chamber. Upon completion of the thermal process, the end effector is inserted into the processing chamber and retrieves the wafer 17 for transport to the next step in fabrication.

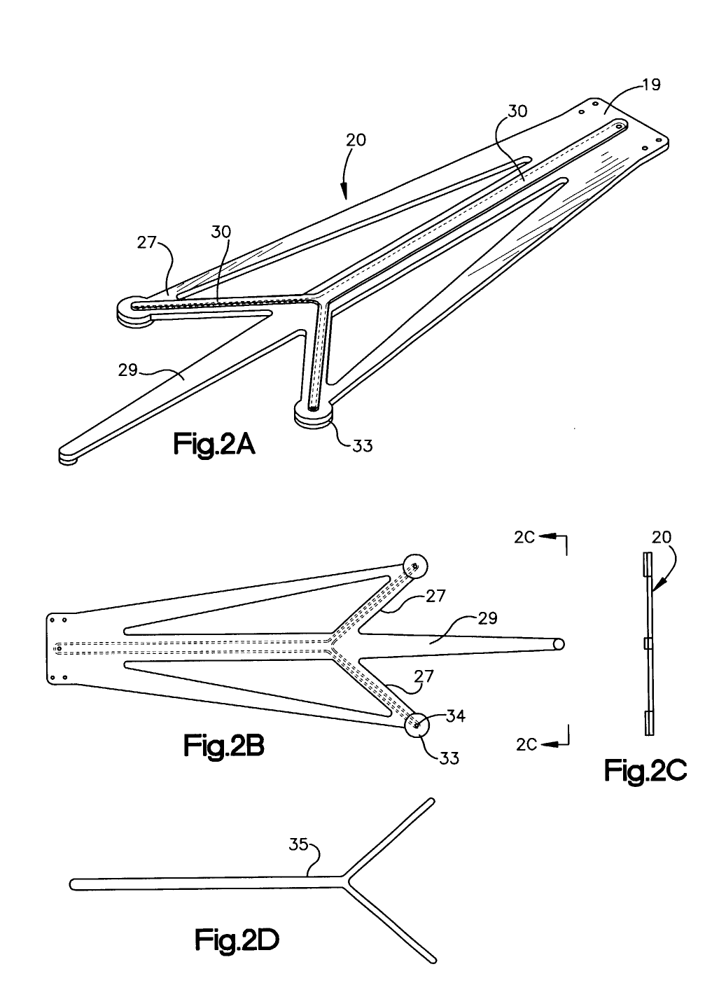

FIGS. 2A-2D show the end effector 20 in more detail. The end effector includes a body portion 25 that is made of a ceramic material such as quartz, alumina, or silicon carbide, but preferably alumina. The body portion 25 is generally planar in shape and features a robot arm mounting end 19, and two outer wafer engaging fingers 27 and a center wafer support finger 29 at an axial end. The outer wafer engaging fingers 27 each have a wafer support pad 33 that supports the wafer during handling without damaging the wafer surface.

Within the body portion 25, an interior vacuum passageway 30 (shown in phantom) passes from the robot mounting end 19 to vacuum orifices 34 located in each wafer support pad. The vacuum passageway is formed from a groove that is machined in the surface of the body portion 25 that is opposite the surface that includes the wafer support pads. The groove is approximately five millimeters wide. A backplate 35 (FIG. 2D) is welded to the body portion over the groove 30 to seal the passageway so that vacuum can pass from the robot mounting end 19 to the vacuum orifices 34. Known vacuum fittings are located in the robot mounting end 19 to connect the interior vacuum passageway to an exterior gas supply.

Although the present invention has been described with a degree of particularity, it is the intent that the invention include all modifications and alterations from the disclosed design falling within the spirit or scope of the appended claims.

We claim:

1. For use in the thermal processing of semiconductor wafers, an end effector for installation on a robotic arm for transporting a plurality of semiconductor wafers from one location to another, the end effector comprising a ceramic end effector body portion comprising a plurality of wafer support pads adapted to support a semiconductor wafer surface, wherein at least one of the support pads comprises a vacuum orifice, and wherein the body portion comprises an interior vacuum passageway having a first end that is adapted to connect to a vacuum source and a second end that terminates at the vacuum orifice such that a reduced gas pressure at the first end causes a vacuum to be exerted at the vacuum orifice.

2. The end effector of claim 1 wherein the interior passageway is formed from a groove in the end effector body portion and an end effector backplate that is sealingly connected to the end effector body portion to completely cover the groove from the first end to the second end.

3. The end effector of claim 1 wherein the ceramic body portion is made of alumina.

4. The end effector of claim 1 wherein the ceramic body portion is made of silicon carbide.

5. The end effector of claim 1 wherein the end effector comprises a plurality of wafer engaging fingers.

6. The end effector of claim 5 wherein the wafer support pads are disposed at an axial end of the wafer engaging fingers.

7. The end effector of claim 5 comprising three wafer engaging fingers, two of which comprise wafer support pads that include vacuum orifices.
